(19) United States
(12) Patent Application Publication
(10) Pub. No.: US 2013/0075292 A1
(43) Pub. Date: Mar. 28, 2013

(54) TOOLBOX WITH A HINGE DEVICE

(71) Applicant: Shao-Hsien Hsu, Taichung City (TW)

(72) Inventor: Shao-Hsien Hsu, Taichung City (TW)

(21) Appl. No.: 13/684,582

(22) Filed: Nov. 26, 2012

Related U.S. Application Data
(63) Continuation-in-part of application No. 12/758,020, filed on Apr. 11, 2010.

(51) Int. Cl. B25H 3/02

(52) U.S. Cl. CPC B25H 3/02
USPC 206/349

(57) ABSTRACT

A toolbox with a hinge device having a first shell and a second shell includes a first opening defined in the first shell and a second opening defined in the second shell. Two first protrusions are respectively formed on two opposite lateral surfaces of the first opening. Two second protrusions are respectively formed on two opposite lateral surfaces of the second opening. A hinge member is pivotally accommodated in the first and second opening. The hinge member has two pairs of grooves respectively defined in two ends thereof for correspondingly and pivotally engaging with the two first protrusions and the two second protrusions.

### CROSS-REFERENCE TO RELATED APPLICATION

This application is a Continuation-in-part application of Ser. No. 12/758,020 filed 11 Apr. 2010, and entitled “HINGE DEVICE FOR A TOOLBOX”, now pending.

### BACKGROUND OF THE INVENTION

1. Field of the Invention

The present invention relates to a toolbox, and more particularly to a toolbox with a hinge device. 2. Description of Related Art

As shown in FIG. 7, a conventional toolbox with a hinge device 10 has an upper casing 11 and a lower casing 12 which is hinged to the upper casing 11. The upper casing 11 in accordance with the prior art comprises two first protrusions 111 horizontally formed on and protruding from an outer side of the upper casing 11. Each first protrusion 111 has a pivot 112 axially extending from one end thereof The two pivots 112 are in a face-to-face manner. The lower casing 12 has a second protrusion 121 formed on and protruding from an outer side thereof. The second protrusion 121 has two holes 122 axially defined in two opposite ends thereof for respectively and pivotally engaging with the two pivots 112. Therefore, the upper casing 11 and the lower casing 12 are pivotally rotatable with each other when the two pivots 112 respectively engage with the two holes 122.

However, the conventional toolbox with a hinge device 10 has several disadvantages. Firstly the toolbox 10 can not be freely placed in a standing position due to the hinge device protruding from the outer surfaces of the upper casing 11 and the lower casing 12. Secondly, when manufacturing the upper and lower casings 11, 12, the fabrication of the two first protrusions 111 and the second protrusion 121 would require much time and work. Therefore, the conventional toolbox with a hinge device is inconvenient to be used and fabricated.

The present invention has arisen to mitigate and/or obviate the disadvantages of the conventional toolbox with a hinge device.

### SUMMARY OF THE INVENTION

The main objective of the present invention is to provide an improved toolbox with a hinge device.

To achieve the objective, a toolbox with a hinge device has a first shell, a second shell and a hinge member in accordance with the present invention includes a first opening defined at an upper portion of a first wall of the first shell and a second opening defined at an upper portion of a second wall of the second shell. Two first protrusions are respectively formed on and protrude from two opposite lateral surfaces of the first opening. A first gap is defined between each first protrusion and a bottom surface of the first opening. Two second protrusions are respectively formed on and protrude from two opposite lateral surfaces of the second opening. A second gap is defined between each second protrusion and a bottom surface of the second opening. The hinge member is pivotally accommodated in the first opening and the second opening. The hinge member has two pairs of grooves respectively defined in two ends thereof for correspondingly and pivotally engaging with the two first protrusions and the two second protrusions.

Wherein the first opening and the second opening are extended in a horizontal direction relative to the first wall of the first shell and the second wall of the second shell respectively, and the first opening and the second opening respectively have depths which are less than a half of height of the first wall and another half height of the second wall respectively. The hinge member is an elongated plate corresponds to the shapes of the first opening and the second opening for pivotally accommodating in the first opening and the second opening. The hinge member further comprises two opposite ends, each end of the hinge member having three parallel walls longitudinally formed thereon and a primary wall perpendicularly connected to the three parallel walls, the pair of grooves respectively located between the three walls and the primary wall, two opposite walls of the three parallel walls and the primary wall in each end of the hinge member respectively corresponding to a size of each first and second gap such that each of the two first protrusions and the two second protrusions is pivotally disposed in the corresponding groove.

Under this arrangement, the first shell is pivotally hinged to the second shell, and the toolbox is able to be opened/closed by pivotally rotating the first shell and the second shell.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a toolbox with a hinge device in accordance with the present invention;

FIG. 2 is an assembled perspective view of the toolbox with a hinge device in accordance with the present invention as the toolbox is in a closed state;

FIG. 3 is an assembled perspective view of the toolbox with a hinge device in accordance with the present invention as the toolbox is in an open state;

FIG. 4 is a partially cross-sectional view of the toolbox with a hinge device in accordance with the present invention taken along line 4-4 in FIG. 3;

FIGS. 5-6 are partially cross-sectional views of the toolbox with a hinge device in accordance with the present invention taken along line 5-5 in FIG. 2; and

FIG. 7 is a perspective view of a conventional toolbox with a hinge device in accordance with the prior art.

### DETAILED DESCRIPTION OF THE INVENTION

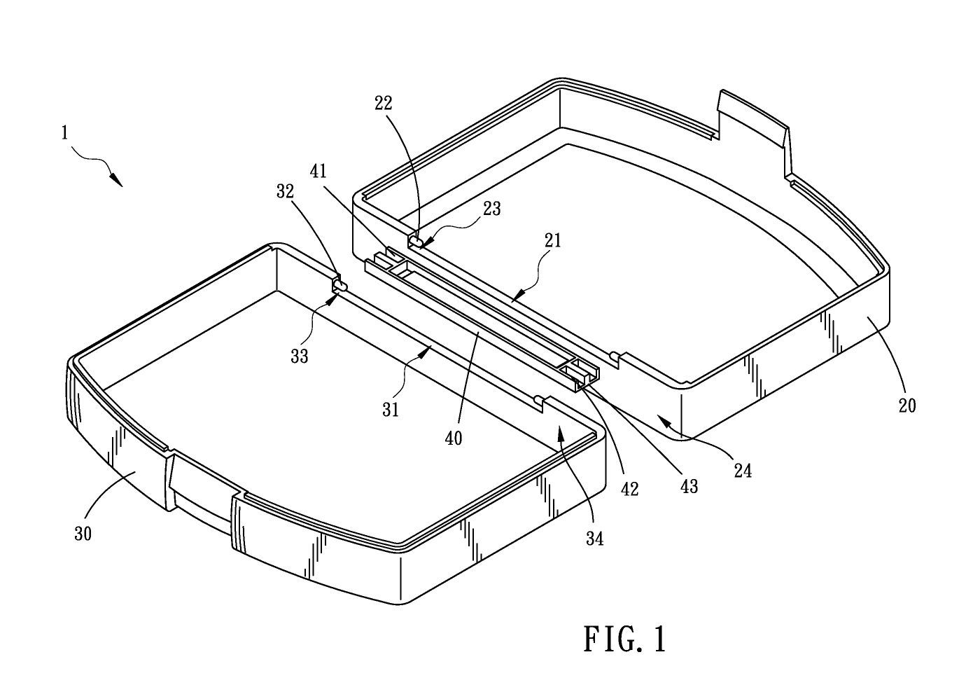

Referring to FIGS. 1-3, a toolbox with a hinge device in accordance with the present invention comprises a toolbox 1. The toolbox 1 has a first shell 20, a second shell 30 and a hinge member 40. The hinge member 40 is disposed on the toolbox 1. The first shell 20 and the second shell 30 are pivotally rotatable with each other via the hinge member 40. The first shell 20 has a first opening 21 defined therein and opened at an upper portion of a first wall 24 of the first shell 20 in a horizontal direction relative to the first shell 20. The second shell 30 has a second opening 31 defined therein and opened at an upper portion of a second wall 34 of the second shell 30 in a horizontal direction relative to the second shell 30. The first opening 21 and the second opening 31 have a substantially same size. In a preferred embodiment, the first opening 21 and the second opening 31 respectively have depths which are less than a half height of the first wall 24 and another half height of the second wall 34 respectively.

Two first protrusions 22 are respectively formed on and symmetrically protrude from two opposite lateral surfaces of the first opening 21. A first gap 23 is defined between each first protrusion 22 and a bottom surface of the first opening 21. Two second protrusions 32 are respectively formed on and symmetrically protrude from two opposite lateral surfaces of the second opening 31. A second gap 33 is defined between each second protrusion 32 and a bottom surface of the second opening 31.

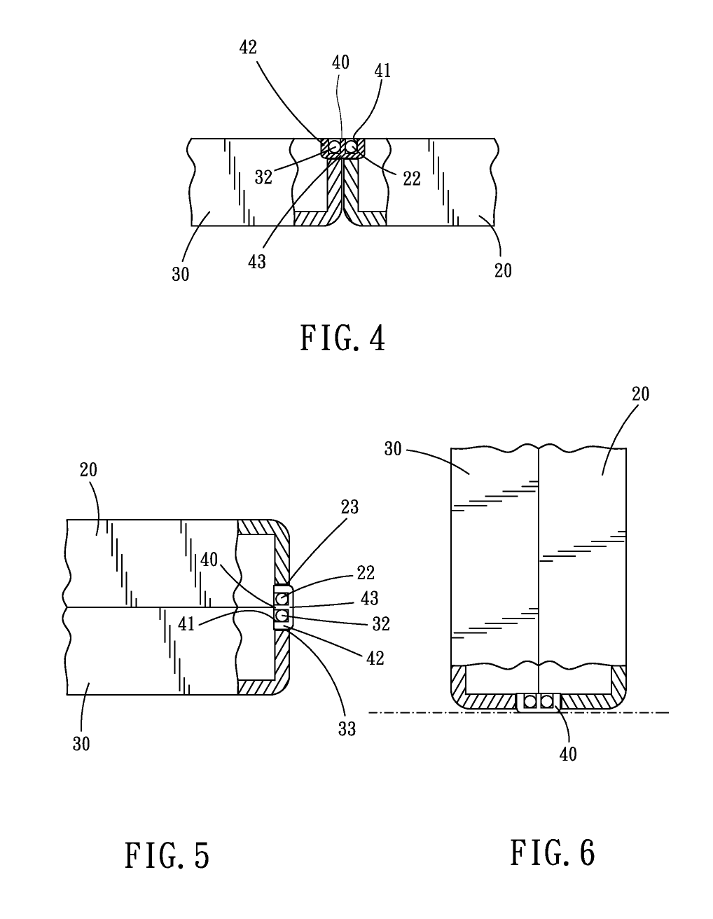

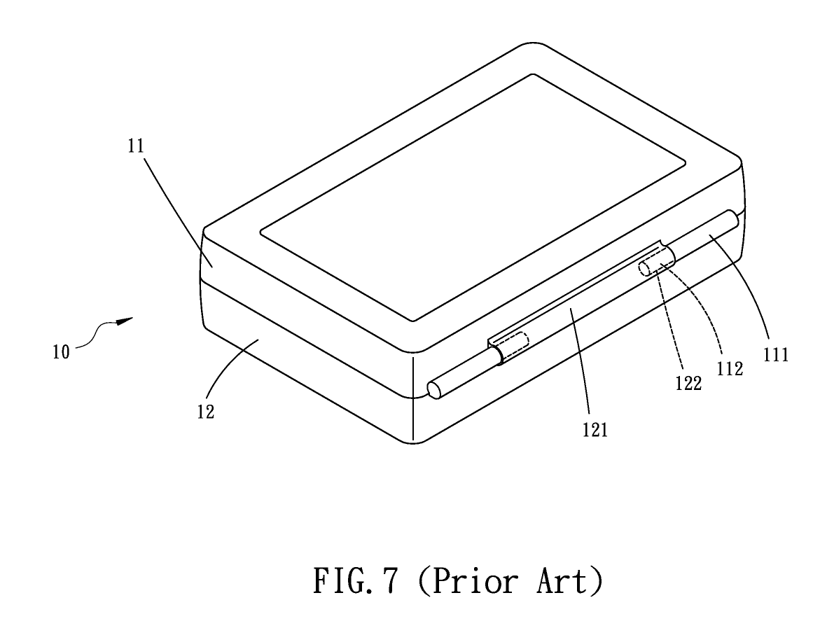

The hinge member 40 is an elongated plate and corresponds to the shapes of the first and second openings 21, 31 for pivotally accommodating in the first opening 21 and the second opening 31. The hinge member 40 has two opposite ends. Each end of the hinge member 40 has three parallel walls 42 longitudinally formed thereon and a primary wall 43 perpendicularly connected to the three parallel walls 42. The three walls 42 and the primary wall 43 define a pair of grooves 41 therebetween. The two pairs of grooves 41 are provided for correspondingly and pivotally engaging with the two first protrusions 22 and the two second protrusions 32. As shown in FIGS. 4-5, two opposite walls of the three parallel walls 42 and the primary wall 43 in each end of the hinge member 40 are respectively corresponded to a size of each first and second gap 23, 33, such that each of the two first protrusions 22 and the two second protrusions 32 is pivotally disposed in the corresponding groove 41. Under this arrangement, the hinge member 40 is disposed on a top of the first wall 24 and another top of the second wall 34, and the two first protrusions 22 and the two second protrusions 32 are plugged into the corresponding grooves 41 respectively. Consequently when the toolbox 1 is open (as shown in FIG. 4), the hinge member 40 is located on the top of first wall 24 and another top of the second wall 34 rather than be abutted against a ground as the prior art. Therefore, when the tool box is opened, the hinge member 40 is prevented from loosing from the toolbox 1 unexpectedly.

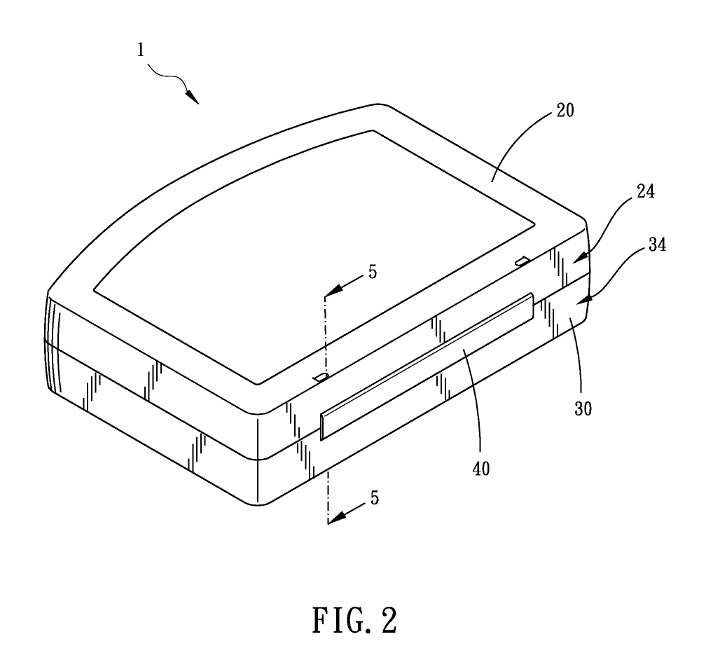

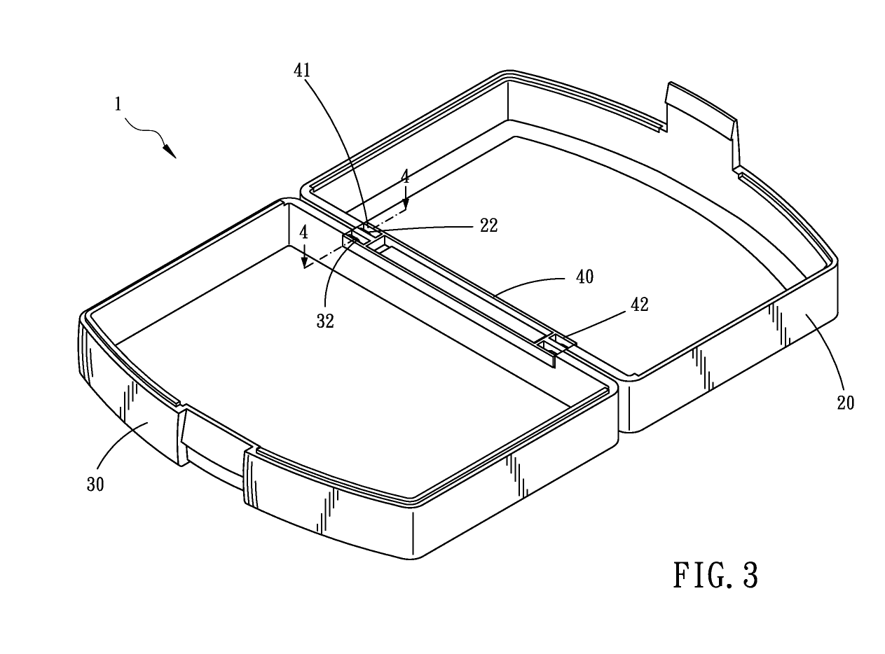

Therefore, as shown in FIGS. 2-3, the first shell 20 and the second shell 30 of the toolbox 1 are pivotally rotatable with each other to make a closed state and an open state of the toolbox 1. And when the toolbox 1 is in the open/closed state, the hinge member 40 is unprotruded from the first wall 24 and the second wall 34 of the toolbox 1. As shown in FIG. 6, when the toolbox 1 is in the closed state, the toolbox 1 is able to be placed stably in a standing position in which the first wall 24 and the second wall 34 of the toolbox 1 with the hinge member 40 contact the ground or a desk.

Although the invention has been explained in relation to its preferred embodiment, it is to be understood that many other possible modifications and variations can be made without departing from the spirit and scope of the invention as hereinafter claimed.

What is claimed is:

1. A toolbox with a hinge device comprising:
a first shell, a second shell and a hinge member connected to the first shell and the second shell;
a first opening defined at an upper portion of a first wall of the first shell, a second opening defined at an upper portion of a second wall of the second shell;
two first protrusions respectively formed on and protruding from two opposite lateral surfaces of the first opening, a first gap defined between each first protrusion and a bottom surface of the first opening, two second protrusions respectively formed on and protruding from two opposite lateral surfaces of the second opening, a second gap defined between each second protrusion and a bottom surface of the second opening; and
the hinge member pivotally accommodated in the first opening and the second opening, the hinge member having two pairs of grooves respectively defined in two ends thereof for correspondingly and pivotally engaging with the two first protrusions and the two second protrusions;
wherein the first shell is pivotally hinged to the second shell via the hinge member and the toolbox is openable/closable by pivotally rotating the first shell and the second shell.

2. The toolbox with a hinge device as claimed in claim 1, wherein the first opening and the second opening are extended in a horizontal direction relative to the first wall of the first shell and the second wall of the second shell respectively.

3. The toolbox with a hinge device as claimed in claim 1, wherein the first opening and the second opening respectively have depths which are less than a half of height of the first wall and another half height of the second wall respectively.

4. The toolbox with a hinge device as claimed in claim 1, wherein the hinge member corresponds to the shapes of the first opening and the second opening for pivotally accommodating in the first opening and the second opening.

5. The toolbox with a hinge device as claimed in claim 1, wherein the hinge member is an elongated plate.

6. The toolbox with a hinge device as claimed in claim 1, wherein the hinge member has two opposite ends, each end of the hinge member having three parallel walls longitudinally formed thereon and a primary wall perpendicularly connected to the three parallel walls, the pair of grooves respectively located between the three walls and the primary wall, two opposite walls of the three parallel walls and the primary wall in each end of the hinge member respectively corresponding to a size of each first and second gap such that each of the two first protrusions and the two second protrusions is pivotally disposed in the corresponding groove.
